(19) United States
(12) Patent Application Publication
(10) Pub. No.: US 2015/0107470 A1
(43) Pub. Date: Apr. 23, 2015

(54) PRINTING PRESS

(71) Applicant: manroland web systems GmbH, Augsburg (DE)

(72) Inventors: Stefan ALBRECHT, Neusaess (DE); Marke Jirous, Gablingen (DE); Xaver Bachmeir, Affing (DE); Stephan Fischer, Augsburg (DE); Christian Trometer, Wollishausen (DE); Norbert Rothenberger, Nordendorf (DE)

(73) Assignee: manroland web systems GmbH, Augsburg (DE)

(21) Appl. No.: 14/515,977

(22) Filed: Oct. 16, 2014

(30) Foreign Application Priority Data
Oct. 18, 2013 (DE) 10 2013 111 534.9

(51) Int. Cl. B41F 3/54

(52) U.S. Cl. CPC B41F 3/54
USPC 101/217; 101/483

(57) ABSTRACT

A printing press with at least one gripperless printing unit of a reel-fed printing press, through which a substrate to be printed can be transported in the horizontal direction by a transport device. A dimensionally stable and relatively stiff piece good, which during the transport and printing does not adapt to cylinder contours of the printing units, can be transported through the or each gripperless printing unit by the transport device. The printing press further includes a feeder, which keeps the piece good to be printed ready and via which the piece good to be printed can be circumference register-precisely and page register-precisely placed on the transport device for the subsequent printing in the printing units.

This application claims the priority of German Patent Document No. DE 10 2013 111 534.9, filed Oct. 18, 2013, the disclosure of which is expressly incorporated by reference herein.

### BACKGROUND AND SUMMARY OF THE INVENTION

The invention relates to a printing press. The invention furthermore relates to a method for operating a printing press.

In printing press construction, a distinction is made in principle between sheet-fed printing presses and reel-fed printing presses.

In a sheet-fed printing press, individual print sheets as substrates to be printed are printed in printing units of the sheet-fed printing press, wherein the print sheets to be printed are transported through the sheet-fed printing press with the help of a gripper system in the printing units. Thus, cylinders of printing units of a sheet-fed printing press and transfer cylinders of the sheet-fed printing press positioned between the printing units are assigned gripper systems, with the help of which a print sheet to be printed is gripped by an in-transport direction of the print sheet front edge in order to thus transport the print sheet to be printed through the individual printing units of the sheet-fed printing press. At the start of the transport section of the print sheets to be printed, the print sheets to be printed are kept ready by a feeder of the sheet-fed printing press, wherein at the end of the transport section following the printing of the print sheets the printed print sheets are delivered via a delivery. In a sheet-fed printing press, substrates which are flexible and accordingly not stiff can be printed as print sheets, i.e., substrates which can adapt in their contour to the circumference of the cylinder of the printing press serving for the sheet transport. Thus, sheets of paper, sheets of cardboard or sheets of flexible sheet metal can be printed as substrates in a sheet-fed printing press.

Reel-fed printing presses have gripperless printing units and serve for the printing of a practically endless substrate, such as for example the printing of an endless paper web to be unwound from a reel. Since in reel-fed printing presses a practically endless substrate web is accordingly printed, printing units of a reel-fed printing press do not have any grippers but merely devices for regulating the position of the substrate web to be printed. Since in reel-fed printing presses no grippers have to be activated, higher printing speeds can be achieved with reel-fed printing presses so that it is consequently possible to print a higher number of copies per unit time in reel-fed printing presses than in sheet-fed printing presses. In reel-fed printing presses, only substrates which are flexible and not stiff, such as for example paper, thin cardboard or films can be printed to date.

Starting out from this, the object of the present invention is based on creating a new type of printing press and a method for operating the printing press.

The printing press according to the invention comprises a transport device via which a dimensionally stable and relatively stiff piece good as a substrate to be printed, which during the transport and printing does not adapt to cylinder contours of gripperless printing units of a reel-fed printing press can be transported through the or each gripperless printing unit, and a feeder, which keeps the piece good to be printed ready and via which the piece good to be printed can be placed on the transport device for the subsequent printing in the gripperless printing units in a circumference register-precise and page register-precise manner.

With the present invention it is provided for the first time to print dimensionally stable and relative stiff piece good as substrate to be printed in gripperless printing units of a reel-fed printing press.

For this purpose, the transport device is employed, with the help of which the dimensionally stable and relatively stiff piece good is transported through the gripperless printing units of the reel-fed printing press for printing. A feeder serves for the circumferential register-precise and page register-precise placing of the dimensionally stable and relatively stiff piece good on the transport device for the register-precise printing of the piece good in the gripperless printing units of the reel-fed printing press.

When printing the piece good in the printing press according to the invention, clearly higher printing speeds than in sheet-fed printing presses can be realized. In addition, it is possible in a simple manner to register-precisely print dimensionally stable and relatively stiff piece good with variable print format, for as long as the print format of the piece good to be printed is smaller than the circumference of a transfer cylinder of the respective printing unit used for printing or maximally corresponds to that circumference.

According to a first advantageous development, the transport device is designed as a conveyor belt system, which comprises at least one conveyor belt tensioned on deflection rollers, wherein the piece good to be printed is preferentially fixed during the transport through the or each gripperless printing unit on the conveyor belt preferentially through gluing or through magnetic effects or through electrostatic effects. According to a second, alternative advantageous further development of the invention, the transport device is designed as a vacuum conveyor belt system or suction conveyor belt system, which comprises at least one vacuum conveyor belt or suction conveyor belt tensioned on deflection rollers, wherein the piece good to be printed is fixed during the transport through the or each gripperless printing unit on the vacuum conveyor belt or suction conveyor belt through vacuum. Both advantageous further developments of the invention allow transporting the piece good to be printed through the printing units of the reel-fed printing press with a high transport speed, which is adapted to the printing speed that can be achieved with reel-fed printing presses. This allows a particularly advantageous printing of the piece good in the gripperless printing units of the reel-fed printing press.

With the transport device, a dimensionally stable and relatively stiff piece good is transported through the or each gripperless printing unit. With the feeder, the piece good is circumferential register-precisely and page register-precisely placed on the transport device for the subsequent printing.

According to an advantageous further development, the piece good to be printed is positioned on the transport device in such a manner that each piece good to be newly placed is positioned on the transport device with a defined spacing from a respective upstream piece good. The defined spacing in this case is preferentially set dependent on a circumference of the transfer cylinder and dependent on a print format of the piece good to be printed.

Preferred further developments of the invention are obtained from the following description. Without being restricted to these, exemplary embodiments of the invention are explained in more detail by the drawings.

### BRIEF DESCRIPTION OF THE DRAWINGS

FIG. 1 is a highly schematic representation of a printing press according to the invention;

FIG. 2 is a detail of the printing press of FIG. 1;

FIG. 3 is an alternative detail of the printing press of FIG. 1;

FIG. 4 is a detail IV of FIG. 2 or FIG. 3 respectively; and

FIG. 5 is a highly schematic representation of a further printing press according to the invention.

### DETAILED DESCRIPTION OF THE DRAWINGS

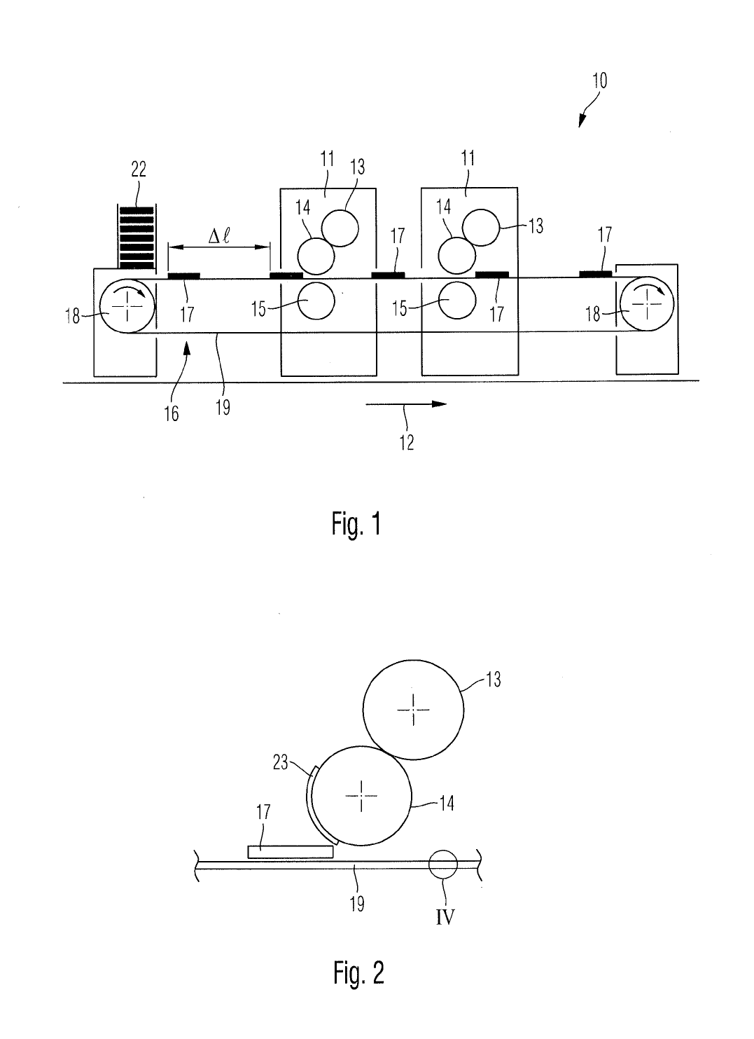

The invention relates to a printing press. FIG. 1 shows a highly schematic view of a printing press 10 according to the invention, wherein the shown exemplary embodiment the printing press 10 comprises a plurality of gripperless printing units 11 of a reel-fed printing press, through which a substrate to be printed can be transported in the horizontal direction 12.

Of the printing units 11, a so-called form cylinder 13, a so-called transfer cylinder 14 and a so-called printing cylinder 15 are each shown in FIG. 1, wherein the substrate to be printed is transported through the printing units 11 in the horizontal direction 12 between the transfer cylinder 14 and the printing cylinder 15.

In addition, the printing units 11 comprise an inking unit which is not shown and preferentially a dampening unit which is not shown.

It is substantial to the invention that the printing units 11 are printing units of a reel-fed printing press, which accordingly do not have any grippers.

The printing press 10 furthermore comprises a transport device 16, via which a dimensionally stable and relative stiff piece good 17 as the substrate to be printed can be transported through the gripperless printing units 11 of the reel-fed printing press. Dimensionally stable and relatively stiff piece good 17 is to mean piece good which during the transport and during the printing does not adapt to cylinder contours of the printing units.

This dimensionally stable and relatively stiff piece good is for example wood chipboard such as MDF-boards, thick cardboards or plate glass.

In the shown exemplary embodiment of FIG. 1, the transport device 16 is designed as a conveyor belt system, which comprises at least one endless conveyor belt 19 tensioned on deflection rollers 18. The dimensionally stable and relatively stiff piece good 17 to be printed is preferentially fixed on the respective conveyor belt 19 for the transport through the gripperless printing units 11.

In the preferred embodiment version of the invention, in which the dimensionally stable and relatively stiff piece good 17 is fixed on the or each conveyor belt 19 through gluing, the respective conveyor belt 19 preferentially has an at least two-layered construction of an outer layer 20 facing the piece good 17 to be printed and an inner layer 21 facing away from the piece good 17 to be printed, wherein the outer layer 20 of the respective conveyor belt 19, on which the piece good 17 is to be fixed through gluing, is preferentially a layer 20 of polyurethane. On such a polyurethane layer, the piece good 17 to be transported and to be printed can be fixed particularly advantageously through gluing and following the printing can also be easily removed from the respective conveyor belt 19 again.

Alternatively to the gluing, the dimensionally stable and relatively stiff piece good 17 can be fixed on the respective conveyor belt 19 through electrostatic effects or magnetic effects or adhesive effects. The respective conveyor belt can be designed as a flat belt or chain belt or link belt. If the conveyor belt is embodied as a link belt, it preferentially comprises a plurality of chain elements which are joined chain-like, the dimensions of which are matched to the print format of the piece good to be printed.

In contrast with this it is also possible that the transport device 16 is designed as a vacuum conveyor belt system or suction conveyor belt system, which comprise at least one vacuum conveyor belt or suction conveyor belt tensioned on deflection rollers.

In this case, the piece good 17 to be printed is then fixed or held on the respective vacuum conveyor belt or suction conveyor belt by vacuum during the transport through the or each gripperless printing unit 11.

Both in the transport direction one after another as well as in the transport direction next to one another, a plurality of conveyor belts, vacuum conveyor belts or suction conveyor belts can be utilized for transporting the piece good 17 to be printed through the gripperless printing units 11 of the printing press 10.

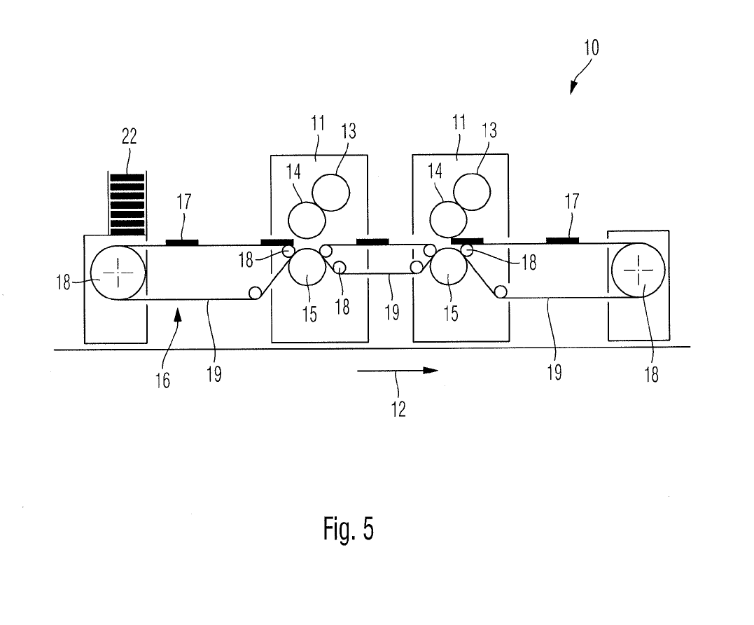

Thus, FIG. 5 shows an embodiment of a printing press 10 which utilizes a plurality of conveyor belts 19 positioned in the transport direction one after another. Between each two printing units 11 positioned one after another and in front of the front-most printing unit 11 as well as behind the rear-most printing unit 11, a conveyor belt 19 each is positioned in this case, which is guided on deflection rollers 18.

In a further alternative embodiment of the invention it can be provided that the transport device 16 comprises reversibly moveable transport tables, wherein such reversibly moveable transport tables however have the disadvantage of a limited production speed. For this reason, the use of a conveyor belt system for transporting the piece good 17 to be printed through the printing units of the reel-fed printing press is preferred.

As is evident furthermore from FIG. 1, the printing press 10 according to the invention furthermore comprises a feeder 22, which keeps the dimensionally stable and relatively stiff piece good 17 ready preferentially in the form of a stack, and which circumference register-precisely and page register-precisely places the piece good 17 to be printed on the transport device 16 for the subsequent printing in the printing units 11.

Downstream of the printing units 11 of the reel-fed printing press, a delivery which is not shown is preferentially present, which receives the printed, dimensionally stable and relative stiff piece good from the transport device 16 after the printing.

With the present invention it is accordingly provided for the first time to print a dimensionally stable and relatively stiff piece good 17 as a substrate to be printed in gripperless printing units 11 of a reel-fed printing press, wherein this piece good 17 to be printed is transported with the transport device 16 through the gripperless printing units 11 of the reel-fed printing press and wherein this piece good 17 to be printed is circumference register-precisely and page register-precisely positioned on the transport device 16 with the help of the feeder 22 for the subsequent printing of the same in the gripperless printing units 11.

The dimensionally stable and relatively stiff piece good 17 to be printed is circumference register-precisely and page register-precisely positioned on the conveyor device 16 with the help of the feeder 22, so that an exact, register-precise printing of the piece good 17 can take place.

The transport device 16, in particular the or each conveyor belt 19 of the transport device, is guided in the printing press stable in the lateral direction and in the circumferential direction. The register precision of the print is solely determined through the placing of the piece good 17 on the transport device 16.

The feeder 22 is activated with the help of a signal, which is preferentially dependent on the angle of rotation position of the cylinder of the printing units 11. This signal can be generated via a rotary position encoder for example of the form cylinder 13 or of the transfer cylinder 14 of one of the printing units 11.

Alternatively, the activation of the feeder 22 for the circumference register-precise and page register-precise positioning of the piece good 17 on the transport device 16 can also take place dependent on the measurement of markers, which are applied to a cylinder 13, 14 or 15 or to a printing form. In contrast with this it is also possible to circumference register-precisely activate the feeder 22 without a marker by scanning the printing form with a camera and an image processing unit connected downstream for identifying image points determined in advance.

The piece good 17 to be printed is positioned by the feeder 22 on the transport device 16 in such a manner that each piece good 17 to be newly placed or newly positioned on the transport device 16 is positioned with a defined spacing Δl to the respective upstream piece good 17 on the transport device 16. This spacing Δl in this case is dependent on the circumference of the transfer cylinder 14 of the printing couples 11 involved in the print and dependent on the print format of the piece good 17 to be printed. According to FIG. 1, the spacing Δl between two piece goods 17 to be printed directly following one another corresponds to the spacing Δl between the trailing edges or alternatively the spacing between the leading edges of the piece goods 17.

In an advantageous further development of the invention, the spacing Δl between two successive piece goods 17 to be printed corresponds to the circumference of the transfer cylinder 14 of the printing units 11. For each cylinder revolution, one piece good 17 is then printed.

The already mentioned circumference register-precise and page register-precise positioning of the piece good 17 on the transport device 16 in this case ensures that the position of the piece good 17 to be printed on the transport device 16 coincides with the position of a print image 23 on the transfer cylinder 14 (see FIG. 2). The remaining area of the transfer cylinder 14 according to FIG. 1 carries no image information.

When the distance Δl between the piece goods 17 to be printed corresponds to the circumference of the transfer cylinder 14 of the printing units 11 of the reel-fed printing press 10, one piece good 17 each is printed for each machine revolution. In contrast with this it is possible to increase the spacing Δl between successive piece goods to twice the circumference of the transfer cylinder 14 of the printing units 11, wherein merely one piece good 17 is then printed with each second machine revolution. When the spacing Δl corresponds to three times the circumference of the transfer cylinder 14 of the printing units 11, piece goods 17 are printed in the printing units 11 with each third revolution of the reel-fed printing press. When the spacing Δl corresponds to n-times the circumference of the transfer cylinder 14 of the printing units 11, piece goods 17 are printed in the printing units 11 with each n-th revolution of the reel-fed printing press.

Typically, a print image 23 to be applied by the respective transfer cylinder 14 onto the respective piece good 17 takes up a relatively large portion of the cylinder circumference of the respective transfer cylinder 14.

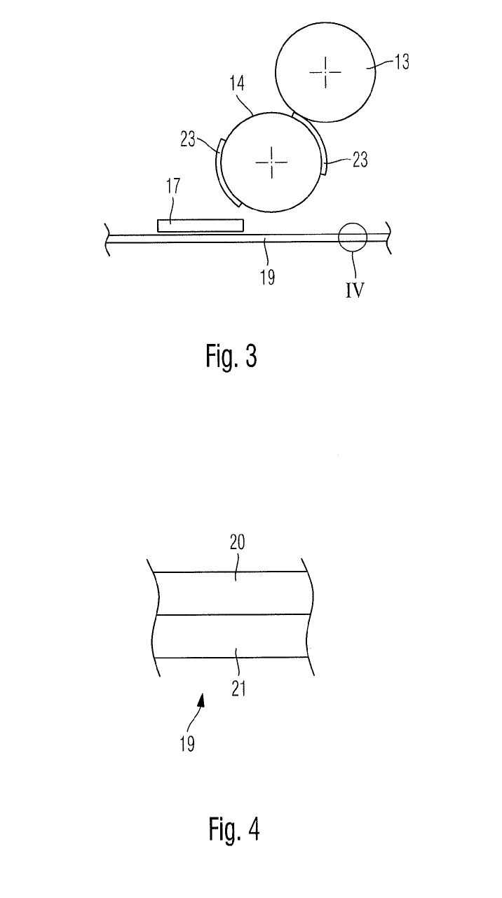

When the image-carrying area of the transfer cylinder 14, which is taken up by the print image 23 to be printed, is smaller than half the cylinder circumference, a plurality of print images on the circumference of the transfer cylinder 14 can be printed one after the other with each cylinder revolution. This is shown by FIG. 3, wherein in FIG. 3 two print images 23 are positioned one after the other on the circumference of the transfer cylinder 14.

In this case, a plurality of piece goods 17 can be printed one after the other per cylinder revolution of the reel-fed printing press, as a result of which the productivity of the reel-fed printing press, in particular in the case of small print formats of the piece goods 17 to be printed can be increased.

In this case, the spacing Δl between piece goods 17 following one another is not only determined dependent on the circumference of the transfer cylinder 14 of the printing units 11, but rather additionally dependent on the print format of the piece goods 17 to be printed.

When for each revolution of the transfer cylinder 14 of the printing units 11 and thus for each revolution of the reel-fed printing press 10 two piece goods 17 are to be printed, the spacing Δl corresponds to half the circumference of the transfer cylinder 14. When for each machine revolution three piece goods 17 are to be printed, the spacing Δl corresponds to a third of the circumference of the transfer cylinders 14. When for each machine revolution a number m of piece goods 17 is to be printed, the spacing Δl corresponds to an m-th of the circumference of the transfer cylinder 14.

Preferentially, the print images 23 to be printed are evenly distributed over the circumference of the transfer cylinders 14 of the printing units 11. In this case, the spacing Δl between the piece goods 17 is then also even. In contrast with this it is also possible with an appropriate activation of the reel-fed printing press 10 to carry out a non-even distribution of the print images 23 on the circumference of the transfer cylinders 14.

Viewed in the axial direction of the cylinders of the printing units 11, a plurality of piece goods 17 each can be printed simultaneously per cylinder revolution, wherein then a plurality of piece goods 17 are positioned next to one another on the feeder 22 over the width of the transport device 16.

With the present invention, it is consequently possible for the first time, utilizing the advantages of printing units 11 of a reel-fed printing press, to circumference register-precisely and page register-precisely print a dimensionally stable and relatively stiff piece good 17 on such printing units.

Here, format-variable printing can be performed, i.e., piece goods 17 can be printed with different print formats. The printable print format maximally corresponds to the circumference of the transfer cylinders 14.

Preferentially, the printing units 11 of the printing press 10 are all embodied as offset printing units. Likewise, all printing units can be embodied as gravure units or as screen printing units.

In contrast with this it is also possible that first printing units 11 of the printing press are designed as offset printing units, whereas second printing units 11 of the printing press are designed as gravure units and/or as letterpress, in particular flexographic printing units and/or as screen printing units. The second printing units 11 can be positioned as seen in the transport direction of the piece goods 17 upstream or downstream of the first printing units 11.

When printing the piece good 17 in the printing press 10 according to the invention, significantly higher printing speeds than in sheet-fed printing presses can be realized. It is possible in a simple manner to print format variably and register-precisely print a dimensionally stable and relatively stiff piece good 17.

The print format of the piece good 17 to be printed is smaller than the circumference of the transfer cylinder 14 of the respective printing units 11 used for printing or maximally corresponds to that circumference. The transfer cylinders 14 used for the printing transfer on their circumference at least one print image or subject. Preferentially, the transfer cylinders 14 transfer for each revolution a plurality of print images or subjects, so that a plurality of print images or subjects is then transferred on the circumference one after another.

The circumference register-precise and page register-precise placing of the piece good 17 to be printed on the transport device 16 via the feeder 22 for the subsequent printing of the piece good 17 is carried out circumference register-precisely and page register-precisely to the or each print image or subject on the circumference of the transfer cylinder 14.

### LIST OF REFERENCE NUMBERS

10 Printing press
11 Printing unit
12 Transport direction
13 Form cylinder
14 Transfer cylinder
15 Printing cylinder
16 Transport device
17 Piece good
18 Deflection roller
19 Conveyor belt
20 Layer
21 Layer
22 Feeder
23 Print image

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reel-fed printing press, comprising:
a gripperless printing unit;
a transport device, wherein a dimensionally stable and relatively stiff piece good is transportable by the transport device through the gripperless printing unit; and
a feeder, wherein the feeder circumference register-precisely and page register-precisely positions the piece good on the transport device for a subsequent printing of the piece good in the gripperless printing unit.

2. The reel-fed printing press according to claim 1, wherein the feeder positions the piece good on the transport device such that the piece good is positioned on the transport device with a defined spacing to an upstream piece good on the transport device.

3. The reel-fed printing press according to claim 2, wherein the defined spacing is dependent on a circumference of a transfer cylinder of the printing press and dependent on a print format of the piece good.

4. The reel-fed printing press according to claim 3, wherein, when for each revolution of the transfer cylinder a number m of piece goods is printed, the defined spacing corresponds to an m-th of a circumference of the transfer cylinder.

5. The reel-fed printing press according to claim 3, wherein, when with each n-th revolution of the transfer cylinder a piece good is printed, the defined spacing corresponds to n-times a circumference of the transfer cylinder.

6. The reel-fed printing press according to claim 1, wherein the feeder is activated for the circumference register-precise and page register-precise positioning of the piece good on the transport device dependent on an angle of rotation position of a cylinder of the printing press or dependent on a measurement of a marker which is applied to the cylinder or a print form or dependent on a markerless scanning of a print form.

7. The reel-fed printing press according to claim 1, wherein the transport device is a conveyor belt system which includes a conveyor belt tensioned on deflection rollers and wherein the piece good is fixed on the conveyor belt.

8. The reel-fed printing press according to claim 7, wherein the piece good is fixed on the conveyor belt through an electrostatic effect or a magnetic effect or an adhesive effect or through gluing.

9. The reel-fed printing press according to claim 7, wherein the conveyor belt has a multi-layered construction and wherein the piece good is fixed through gluing on an outer polyurethane layer of the conveyor belt.

10. The reel-fed printing press according to claim 1, wherein the transport device is a vacuum conveyor belt system which includes a vacuum conveyor belt or a suction conveyor belt system which includes a suction conveyor belt and wherein the piece good is fixed on the vacuum conveyor belt or the suction conveyor belt by a vacuum.

11. The reel-fed printing press according to claim 1, further comprising a delivery, wherein a printed piece good from the transport device is receivable on the delivery.

12. The reel-fed printing press according to claim 1, wherein the gripperless printing unit is a gripperless offset printing unit.

13. The reel-fed printing press according to claim 1, wherein the gripperless printing unit is a gripperless offset printing unit and further comprising a second gripperless printing unit, wherein the second gripperless printing unit is a gravure unit and/or a letterpress unit and/or a screen printing unit.

14. A method for operating a reel-fed printing press, comprising the steps of:
transporting a dimensionally stable and relatively stiff piece good by a transport device through a gripperless printing unit; and
circumference register-precisely and page register-precisely positioning of the piece good on the transport device for subsequent printing of the piece good in the gripperless printing unit by a feeder.

15. The method according to claim 14, further comprising the step of positioning the piece good on the transport device by the feeder with a defined spacing to an upstream piece good on the transport device wherein the defined spacing is dependent on a circumference of a transfer cylinder of the printing press and dependent on a print format of the piece good.
